(19) United States
(12) Patent Application Publication
(10) Pub. No.: US 2013/0114157 A1
(43) Pub. Date: May 9, 2013

(54) Silicon focusing mirror system

(71) Applicant: Alex K. Deyhim, Ithaca, NY (US)

(72) Inventor: Alex K. Deyhim, Ithaca, NY (US)

(21) Appl. No.: 13/373,125

(22) Filed: Nov. 4, 2011

(51) Int. Cl. G02B 7/182

(52) U.S. Cl. 359/872

(57) ABSTRACT

In this paper we will describe the design of a silicon mirror system. The mirror system consists of five primary subcomponents. The mirror optic itself, its positioning system, the bending mechanism, a vacuum chamber, and the support structure all provided as an integrated package. All subsystems were designed to provide the highest positional stability and structural rigidity with precision motions on all axes.

### CROSS REFERENCE TO RELATED APPLICATIONS

Not applicable

### STATEMENT REGARDING FEDERALLY SPONSORED RESEARCH OR DEVELOPMENT

Not applicable

### SEQUENCE LISTING OR PROGRAM

Not applicable

### BACKGROUND OF THE INVENTION

A mirror system is used in combination with beamline components for tests and developments in the field of x-ray optics and synchrotron radiation. The mirror system uses a combination of subcomponents combined together to create a structure designed for the highest level of stability and functionality for such applications. The focusing mirror component is fabricated from silicon because of the materials regular crystal structure throughout, making it an excellent engineering material.

### SUMMARY OF THE INVENTION

The mirror system described herein consists of five primary subcomponents: The mirror optic itself, its positioning system, the bending mechanism, a vacuum chamber, and the support structure all provided as an integrated package. All subsystems were designed to provide the highest potential stability and structural rigidity with precision motions on all axes.

The mirror is positioned within its vacuum vessel by stepper motor driven slides (X) and jacks (Y), with five motor driven motions; the mirror has five degrees of freedom (X, Y, pitch, roll and yaw) with remarkable precision. The mirror is mounted via flexible linkages to a rigid base plate, this flexibility allows thermal motions of the mirror, eg., during a vacuum bake. One end of the mirror is essentially floating on linkages. Bellows attached to the base plate at three points separate the mirror from the chamber so that no vibrations from the rest of the beamline are imparted to the mirror, reducing optical jitter. All motions are driven from outside the vacuum envelope.

The bender mechanism is driven by a linear stepper motor outside the vacuum space, again separated by a floating bellows. The actuator bends a pair of long leaf springs equally via a waffle tree linkage. The leaf springs impart a pure bending moment to each end of the mirror via a pivoting clamp in the manner of Howells and Lunt [1]. The clamp holds the mirror at each end of its length but outside the optically active surface to avoid local distortions marring the beam quality.

The stainless steel vacuum chamber is robustly constructed with numerous ports for gauging and any required instrumentation. A door the full size of side of the chamber allows easy access to the mirror for any internal operations. The door seal is by a knife edge like compression of a pure aluminum foil gasket ensuring leak tight UHV operation and ease of sealing compared to tricky wire seals. Viewports on the side and top of the chamber allow for quick inspection of the mirror surface and visual proof of the bender mechanism operation.

A massive natural granite plinth is used to support the mirror chamber and all the mirror motions. Granite damps floor vibrations before they can reach the mirror and beamline and is supported by a triplet of fully adjustable feet for course positioning.

### BRIEF DESCRIPTION OF DRAWINGS

The invention as described herein with references to subsequent drawings, contains similar reference characters intended to designate like elements throughout the depictions and several views of the depictions. It is understood that in some cases, various aspects and views of the invention may be exaggerated or blown up (enlarged) in order to facilitate a common understanding of the invention and its associated parts.

FIG. 1 shows the schematic of the entire mirror system.

FIG. 2 shows the wiffle tree linkage.

FIG. 3 shows the bending mechanism.

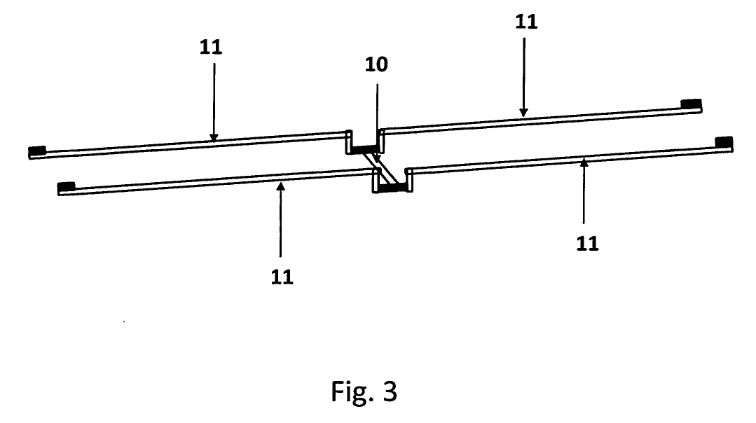

FIG. 4 is a table shows the adjustment range of the mirror.

FIG. 5 is a table showing extremes of five degrees of freedom.

### DETAILED DESCRIPTION OF INVENTION

Provided herein is a detailed description of one embodiment of the invention. Therefore, specific details enclosed herein are not to be interpreted as limiting, but rather as a basis for the claims and as a representative basis for teaching one skilled in the art to employ the present invention in virtually any appropriately detailed system, structure, or manner.

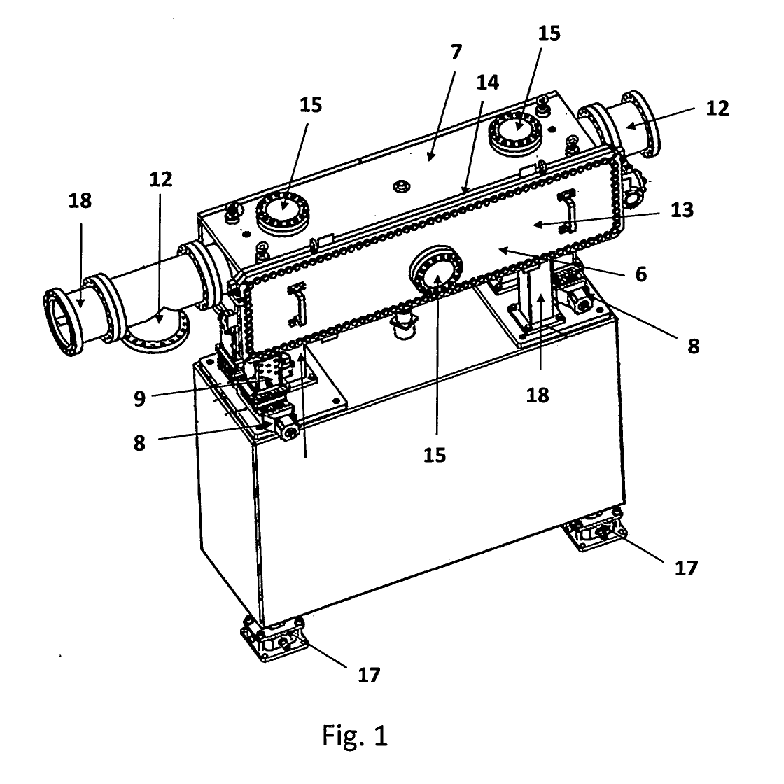

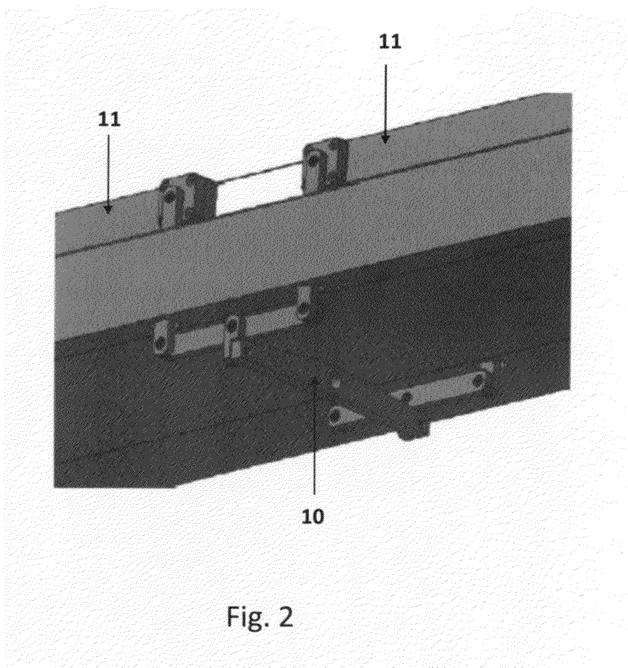

FIG. 1 shows the overall mirror design, with mirror system within 6. The mirror optic in this case is created from a silicon substrate. The silicon mirror substrate is ground from a single crystal boule, a single crystal ingot produced synthetically, and is then polished by a specialist synchrotron mirror vendor. In order to provide horizontal focusing of a wide bend magnet fan, the substrate is ground with a cylindrical recess in its reflecting surface. Gravity deforms the mirror substrate since it is supported only at the ends, so in order to compensate for the gravitational forces, a series of light springs provide an upward force along the edge of the mirror. The support springs are pre-stressed to prevent long-term relaxation and set to provide the necessary force within +/−2%, seen in FIG. 2.

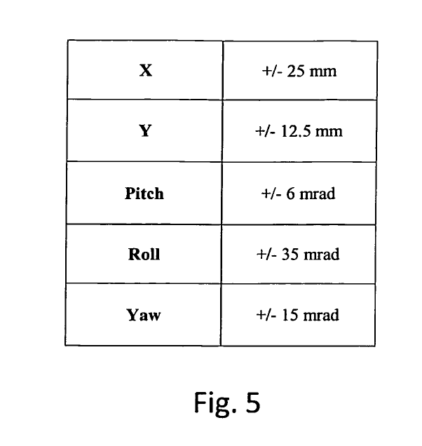

The mirror is positioned within its vacuum vessel 7 by stepper motor driven slides (X direction) 8 and jacks (Y direction) 9, with five motor driven motions; the mirror motion has five degrees of freedom (X, Y, pitch, roll and yaw) with remarkable precision, degrees of which are specified in FIG. 5. X and Y directions are straightforward. Pitch, roll and yaw refer to movements of objects measured in angles. Pitch refers to movement upwards and downwards, similar to a box lid. Roll refers to left and right movement, similar to that of a door on a hinge. Yaw refers to rotation. Note there is not motion in the Z (along the beam direction) since there is not a need for it.

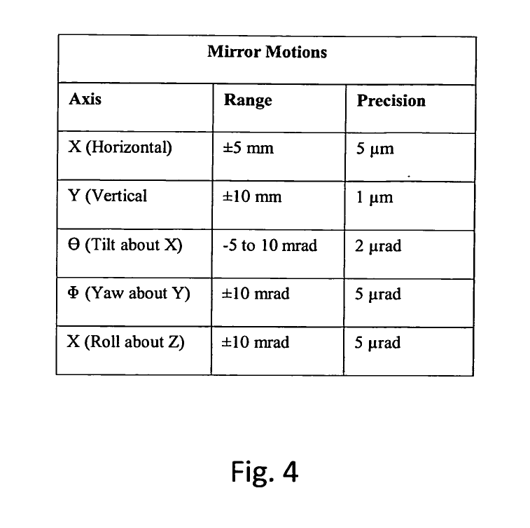

The mirror is supported on flexible pivot linkages to a base plate within the chamber. Rigid rods support the base plate at three points separated from the chamber by bellows 18, so that no vibrations from the rest of the beamline are imparted to the mirror reducing optical jitter. All motions are driven from outside the vacuum envelope. One end of the mirror has flexibility in the roll direction so that no twists can be imparted to the mirror. The mirror is essentially floating on linkages. Bellows attached to the base plate at three points separate the mirror from the chamber so that no vibrations from the rest of the beamline are imparted to the mirror reducing optical jitter. All motions, as described in FIG. 4, are driven from outside the vacuum envelope.

The vacuum enclosure provides a UHV, ultra-high vacuum, compatible environment for the mirror and mirror bender. It also provides the necessary motions for precision and reproducible alignment of the mirror to the x-ray beam. The stainless steel vacuum chamber 7, as in FIG. 1, is robustly constructed with numerous ports 12 for gauging and any required instrumentation. A door 13 the full size of side of the chamber allows easy access to the mirror for any internal operations. The door seal is by a knife edge like compression of a pure aluminum foil gasket 14 ensuring leak tight UHV operation and ease of sealing compared to tricky wire seals. Viewports 15 on the side and top of the chamber allow for quick inspection of the mirror surface and visual proof of the bender mechanism operation.

As described previously, the mirror is supported through a system of flexure style bearings that significantly reduce the residual stresses in the mirror due to machining tolerances in the mounting scheme. Clamping of the ends of the mirror and applying force to each of the four arms, clamped to each of the four corners of the mirror, accomplishes the bending. The force is equal on each arm, long leaf spring bar 11, due to the wiffle tree linkage 10, as shown in FIG. 2.

A massive natural granite plinth, stand 16, is used to support the vacuum chamber containing the mirror system, and all mirror motions. The granite material damps floor vibrations before they can reach the mirror and beamline. The stand itself is supported by a triplet of fully adjustable feet 17 for coarse positioning. The stand also has chamber support stacks 18 affixed to the top surface and subsequently attached to the vacuum chamber.

What is claimed is:

1. A focusing mirror system comprised of:
(a) The mirror optic;
(b) The mirror positioning system;
(c) The bending mechanism;
(d) A vacuum chamber;
(e) And the support structure.

2. The apparatus of claim 1 wherein said mirror optic is comprised of a silicon substrate.

3. The apparatus of claim 2 wherein said mirror optic is ground from a single silicon crystal boule, and polished.

4. The apparatus of claim 1 wherein the mirror is positioned using stepper motor driven slides for the x direction and jacks for the y direction.

5. The apparatus of claim 1 wherein the positioning system allows for mirror motion in five degrees of freedom, including x and y, and additionally, pitch, roll and yaw.

6. The apparatus of claim 1 wherein the positioning system does not allow for motion in the Z direction, along the beamline.

7. The apparatus of claim 1 wherein said bending mechanism is required due to mirror deformation from forces of gravity.

8. The apparatus of claim 1 wherein said bending mechanism is comprised of:
(f) Support springs;
(g) Long leaf spring bar style arms;
(h) And wiffle tree linkage.

9. The apparatus of claim 8 wherein said support springs are pre-stressed to prevent long-term relaxation.

10. The apparatus of claim 8 wherein said long leaf spring bar arms are clamped to the corners of the mirror, providing equal force to accomplish bending, reverse to that of gravitational pull force.

11. The apparatus of claim 8 wherein said wiffle tree linkage is in place to link long leaf spring bar arms together, producing equal force distribution to each arm.

12. The apparatus of claim 1 wherein said vacuum chamber provides an ultra-high vacuum compatible environment for the mirror and mirror bender.

13. The apparatus of claim 1 wherein said vacuum chamber is made of stainless steel.

14. The apparatus of claim 1 wherein said vacuum chamber contains numerous ports for viewing mirror surface, gauging, and any required instrumentation.

15. The apparatus of claim 1 wherein said vacuum chamber has a door the full size of the side of the chamber, allowing easy access to the mirror and mirror bender mechanism.

16. The apparatus of claim 15 where said door has a seal by a knife edge like compression of a pure aluminum foil gasket to ensure leak tight UHV operation and ease of sealing.

17. The apparatus of claim 1 wherein said support structure is a massive granite plinth, as granite damps vibrations before said vibrations can reach the mirror and beamline.

18. The apparatus of claim 1 wherein said support structure itself, is supported by a triplet of fully adjustable feet, providing coarse positioning for the entire system.

19. The apparatus of claim 1 wherein said support structure also has chamber support stacks to hold vacuum chamber.
